(19) United States
(12) Patent Application Publication
(10) Pub. No.: US 2020/0406325 A1
(43) Pub. Date: Dec. 31, 2020

(54) FIN STRAIGHTENING TOOL AND METHOD FOR STRAIGHTENING BENT RADIATOR FINS

(71) Applicant: Robert Bogdan, Belle Chasse, LA (US)

(72) Inventor: Robert Bogdan, Belle Chasse, LA (US)

(21) Appl. No.: 16/457,562

(22) Filed: Jun. 28, 2019

(51) Int. Cl. B21D 3/16; B23P 15/26; B23P 6/00; B21D 53/02

(52) U.S. Cl. CPC B21D 3/16; B21D 53/022; B23P 6/00; B23P 15/26

(57) ABSTRACT

The present disclosure provides for fin straightening tools for a heat radiator configured with fins forming elongated air passages. The fin straightening tool comprises an elongated rod member having a proximal end opposite a distal insertion end and a body comprising a cross-section adapted to geometrically align closely with a geometric cross-sectional shape of an air flow passage formed between fins of a radiator. The body forms two opposing planar surfaces configured as flat to slidingly engage opposing external flat surfaces of radiator fins to structurally mate against the external flat surfaces. The distal insertion end of the rod member is angled and beveled. The present disclosure further provides methods of using the fin straightening tools to straighten bent radiator fins, including to form a scaffolding support structure, to straighten a damaged area of a radiator.

### BACKGROUND OF THE INVENTION

### Field of the Invention

The present invention generally relates to a radiator repair tool and more particularly relates to a tool for straightening bent radiator and heat exchanger fins or other closely situated thin, malleable, conductive materials.

### Description of the Related Art

The use of fin-type heat exchangers is widespread, particularly in heatsinks for electrical systems and heat exchangers for condensers, evaporators, and radiators for air conditioning, refrigeration systems, automobiles, and motorcycles. These systems utilize a multitude of metal fins to improve the transfer of heat from the components of these units into the atmosphere by increasing the effective area of heat transfer surfaces. The metal fins implemented in these systems tend to be attenuated and therefore are very fragile. Due to the fragile nature of these fins, they are often easily damaged or deformed which results in decreased effectiveness and efficiency of the necessary cooling effect they are so employed to perform. Damaged or deformed fins of radiators are not aesthetically pleasing. In the worst cases, this decrease of efficiency and effectiveness can result in permanent damage to the systems utilizing the heat exchangers and heatsinks. Therefore, it becomes necessary to reform or straighten these bent, damaged, or deformed fins back to their original efficient and effective shape to restore the aesthetics of the radiator and before destruction of the systems occur.

Over the years, many devices have been developed and marketed to address the issue of deformed and bent metal fins. Some common methods for reforming or straightening said fins utilize combs with stationary teeth inserted between the fins by a user, which are then manually pulled through the spacing between adjacent fins. These methods require substantial force, which is difficult and time consuming. Other common methods for reforming or straightening said fins utilize modified pliers and modified clips, which are manually inserted between the metal fins of a heat exchanger and then pulled along the outer surfaces of these components to straighten the deformed or damaged fins.

Many configurations of heat exchanger fins have been developed, some of the straight parallel metal sheet or plate type, known as straight fin or plate fin heat exchangers, others consist of tubular structures, known as shell and tube heat exchangers, and others which are very commonly used in the automotive and HVAC industries are known as microchannel heat exchangers. Microchannel heat exchangers typically utilize fin structures with a “V” shape, “M” shape, or hexagonal shape. Various compositions of heat exchanger fins exist and are typically composed of conductive materials, such as aluminum, lead, copper, and/or brass.

Currently, the material of choice for many manufacturers of heat exchanger fins is aluminum, due to the reduced cost and weight as compared to other conductive materials. However, aluminum is typically a very malleable material, which is therefore prone to deformation and bending, decreasing the overall efficiency and effectiveness of the heat exchangers. The various devices and methods employed for straightening radiator fins are commonly directed towards the straight fin or plate fin type heat exchangers, which require the straightening tools to be raked through the open channels between each fin. However, such commonly used devices are ineffective when implemented in the microchannel type heat exchanger fins. Therefore, there is a need for a simplistic, hand-held, effective, and portable device and method for more efficiently penetrating and repairing bent or deformed microchannel heat exchanger fins.

A conventional tool for straightening radiator fins is provided in U.S. Pat. No. 2,818,757A issued to Pille, which discloses a clip-like device resemblant of a money clip, which has rounded edges to prevent scraping of the fins being straightened and a rounded bight portion which rests in a person's palm while the thumb and index fingers extend along the leg members of the device. The user then placed the device with one sheet/plate/fin disposed between the two leg members. The device is then moved manually, parallel to the direction of the rows of fins. As provided therein, such a device must be manually operated by hand, requiring the person using it to possess enough strength to squeeze the leg members together and move the device. Such devices are ineffective for use in microchannel heat exchangers and are inconvenient in use.

U.S. Pat. No. 3,892,123 issued to Baldwin discloses a tool for straightening bent or deformed fins of heat exchangers of a type illustrated by heat exchangers used as condensers and evaporators in air conditioners. The device disclosed is constructed with a plurality of rectangular blades, with each blade separated in parallel planes and connected to a handle. The handle of the device can then be twisted to vary the spacing between the blades. To use, the blades of the tool are inserted with the fins disposed between each blade and the handle is twisted until the spacing of the blades matches that of the fins. Then a person rakes the device back and forth while holding the handle, until the fins are straightened. The primary shortcomings are the complicated twisting mechanism, which leaves vast room for error, potentially further deforming the fins, the strength required for the raking motion, and the devices inability to be utilized with microchannel heat exchanger fins.

More recently, U.S. Pat. No. 6,338,265 B1 issued to Grigg discloses a device for straightening metal fins on heat exchangers used in air conditioning and refrigeration systems. The device is comprised of interchangeable, detachable combs that are made to vibrate by an electrically powered vibrator. To use, the vibrating combs are moved between adjacent fins to straighten them and comes with various sized combs. However, with such devices, often the brush fibers of the combs are not strong enough to straighten the fin and are not efficient for use with microchannel heat exchangers.

A myriad of devices and methods have been patented, which attempt to solve the issue of deformed and bent metal fins. Others are disclosed in the following U.S. patents which have been granted for methods and devices used to straighten deformed and bent metal fins:

| U.S. Pat. No. | Inventor |
|---|---|
| 2,607,249 | Johnston |
| 2,895,358 | Johnson |
| 3,041,900 | Wagner |
| 2,912,888 | Webb |
| 4,018,076 | Wagner |
| 3,531,975 | Lance |

While these units may be suitable for the particular purpose employed, they would not be as suitable for the purposes of the present invention as disclosed hereafter.

Accordingly, there is a need for a compact portable, simplistic device and methods that can efficiently and effectively straighten fins of various styles of microchannel heat exchangers.

One object of the invention is to restore the effectiveness and efficiency of radiator fins to prevent damage to the systems the radiator utilized to cool.

Yet another object is to restore the aesthetics of a radiator, such as, the radiator of a motorcycle.

As disclosed in this application, the inventor has discovered novel and unique devices and methods for efficient and effective straightening of fins of various styles of microchannel heat exchangers, which exhibit superlative properties without being dependent on heavy, immobile, expensive or complex components.

Embodiments of the present invention provide for devices and methods disclosed herein and as defined in the annexed claims which provide for an improved radiator repair tool and more particularly relates to a tool for straightening bent radiator and heat exchanger fins or other closely situated thin, malleable, conductive materials.

### SUMMARY OF THE INVENTION

It is one prospect of the present invention to provide one or more novel devices of simple but effective construction which can be applied to many environments to efficiently and effectively straighten damaged radiator fins, to increase the effectiveness, efficiency, and aesthetics of a radiator.

The following presents a simplified summary of the present disclosure in a simplified form as a prelude to the more detailed description that is presented herein.

Therefore, in accordance with embodiments of the invention, there is provided a fin straightening tool for a heat radiator configured with fins forming elongated V-shaped air passages therethrough. The fin straightening tool includes an elongated rod member having a proximal end opposite a distal insertion end and a body comprising a triangular cross-section. The body forms two opposing planar surfaces configured as flat to slidingly engage opposing external flat surfaces of radiator fins to structurally mate against the external flat surfaces of the radiator fins. In such preferred embodiment, the distal insertion end of the rod member is angled and beveled to gradually open the passage, which reduces the force required to straighten radiator fins. When a stack of rod members engage opposing external flat surfaces of radiator fins to structurally mate against said external flat surfaces, they form a supportive scaffolding structure. In one embodiment, the proximal end has a thicker cross-section relative to the cross-section of the distal end, and the thickness of the cross-section of the elongated rod member tapers down from the proximal end to a thinner cross-section at the distal end. In another embodiment, the proximal end has a thinner cross-section relative to the cross-section of the distal end, and the thickness of the cross-section of the elongated rod member tapers up from the proximal end to a thicker cross-section at the distal end. In such manners, when a stack of tapered rod members form a scaffolding, each tapered rod member provides a thick insertion point opposing a thin insertion point in the stack; or alternatively, each tapered rod member provides a thin insertion point opposing a thick insertion point in the stack.

In one embodiment, the proximal end is adapted to be grasped by a user's hand to maneuver the elongated rod member through the air passage to straighten bent radiator fins.

In another embodiment, the triangular cross-section is characterized as a right triangle.

In yet another embodiment, the triangular cross-section is characterized as an equilateral triangle.

In one embodiment, the triangular cross-section is characterized as a scalene triangle.

In another embodiment, the triangular cross-section is characterized as an acute triangle.

In yet another embodiment, the triangular cross-section is characterized as an obtuse triangle.

In yet another embodiment, the triangular cross-section is characterized as an isosceles triangle.

In yet another embodiment, the triangular cross-section is characterized as trapezoidal.

In another preferred embodiment, a fin straightening device having an elongated rod member is provided. The elongated rod member of such preferred embodiment has a body extending along a longitudinal axis and has a proximal end opposite a distal insertion end. The body forms two opposing planar surfaces and has a cross-section adapted to geometrically align closely with a geometric cross-sectional shape of an air flow passage formed between fins of a radiator. In such preferred embodiment, the elongated rod member is secured to the radiator by inserting the distal insertion end of the rod member into an air passage opening formed by radiator fins and advancing the rod member through the air passage toward an air passage exit opening such that the opposing planar surfaces of the rod member contacts the fins and moves at least a portion of the fins to clear the air passage until the distal insertion end protrudes out of the air passage exit opening. Preferably, the air passage opening is located on the side of the radiator with an unbent fin, for point of reference the unbent fin is disposed opposite the air passage exit opening having a bent fin, and the rod member is inserted into the unbent fin and advanced through the bent fin, thereby straightening the bent fin.

The elongated rod member is inserted into an unbent fin side of the air passage and advanced through the bent fin side of the air passage.

In one embodiment, the geometric cross-section of the elongated rod member is characterized as a triangle.

In another embodiment, the geometric cross-section of the elongated rod member is characterized as a trapezoid, and the trapezoidal shape is adapted to closely align and pair with a radiator in a lock and key style arrangement.

Preferably, in another embodiment, the distal insertion end of the rod member is angled and beveled.

In accordance with embodiments of the invention, there is provided a preferred method of straightening fins forming an air passage of a heat radiator, having a first step (a) of providing a plurality of elongated rod members. Each elongated rod member has a body forming two opposing non-parallel planar surfaces and a triangular cross-section. The rod members have a proximal end opposite a distal insertion end. Preferably, each elongated rod member is adapted for insertion through a fin air passage defined by a plurality of fins. The method preferably has a second step (b) of inserting the distal insertion end of an elongated rod member of step (b) into at least one unbent fin air passage until the distal insertion end protrudes out of the unbent fin air passage and the elongated rod member of step (b) structurally supports the surrounding fins. In such preferred embodiment, a third step (c) includes inserting the distal insertion end of an elongated rod member of step (c) into a bent fin air passage. Wherein the bent fin air passage is disposed adjacent to the at least one unbent fin air passage of step (b). The distal insertion end of the elongated rod member of step (c) contacts the bent fins and moves at least a portion of the bent fins to clear the air passage until the distal insertion end of the elongated rod member of step (c) protrudes out of the bent fin air passage of step (c). The method preferably has a fourth step (d) of inserting the distal insertion end of an elongated rod member of step (d) into a bent fin air passage, which is disposed adjacent to the bent fin air passage of step (c). The distal insertion end of the elongated rod member of step (d) contacts the bent fins and moves at least a portion of the bent fins to clear the air passage until the distal insertion end protrudes out of the bent fin air passage of step (d). The method preferably has a fifth step (e) of inserting the distal insertion end of an elongated rod member of step (e) into a bent fin air passage, wherein the bent fin air passage is disposed adjacent to the bent fin air passage of step (d). The distal insertion end of the elongated rod member of step (e) contacts the bent fins and moves at least a portion of the bent fins to clear the air passage until the distal insertion end of the elongated rod member of step (e) protrudes out of the bent fin air passage.

In another embodiment, the method further has a step of fully advancing the elongated rod member of step (b) through the air passage of step (b) to remove the elongated rod member from the radiator, and inserting the distal insertion end of the elongated rod member of step (b) into a fifth air passage defined by bent fins. The fifth air passage is disposed adjacent to the air passage of step (e). The elongated rod member of step (b) contacts the bent fins and moves at least a portion of the bent fins to clear and open the fifth air passage until the insertion end protrudes out of the fifth air passage exit opening.

In another embodiment, the method further includes a step of providing at least one pliers having a pair of crossed pivoted handles and a pair of jaws respectively fixed to the handles. In such embodiment, the method has a step of squeezing together at least two of the plurality of elongated rod members with the at least one pliers when disposed within the air passages of the radiator.

In yet another embodiment, each elongated rod member is characterized as having a length sufficient to extend fully through the air passage exit opening of the radiator.

In another embodiment, the proximal end of each elongated rod member is adapted to be grasped by a user's hand to maneuver the rod member through the air passage to straighten bent radiator fins.

In yet another embodiment, each elongated rod member is of unitary construction and is forged, molded, or machined. Preferably, the elongated rod member is constructed from a material selected from a group consisting of plastic, resin, high-density polyethylene, rubber, aluminum, metal, and steel.

In one embodiment, the bent fin air passage of step (c) of the method has an unbent fin entrance opposite a bent fin exit and step (c) includes inserting the distal insertion end of the elongated rod member of step (c) into the unbent fin entrance of the bent fin air passage.

In another embodiment, step (b) of the method further includes a step of (f), in which, inserting the distal insertion end of a second elongated rod member of step (b) into a second unbent fin air passage until the distal insertion end of the second elongated rod member protrudes out of the second unbent fin air passage and the second unbent fin air passage is disposed adjacent to the at least one unbent fin air passage.

In yet another embodiment, step (f) of the method further includes a step of (g), where inserting the distal insertion end of a third elongated rod member of step (b) into a third unbent fin air passage until the distal insertion end of the third elongated rod member protrudes out of the third unbent fin air passage and the third unbent fin air passage is disposed adjacent to the second unbent fin air passage of step (f).

In one embodiment, step (g) of the method further includes a step of (h), in which, inserting the distal insertion end of a fourth elongated rod member of step (b) into a fourth unbent fin air passage until the distal insertion end of the fourth elongated rod member protrudes out of the fourth unbent fin air passage and the fourth unbent fin air passage is disposed adjacent to the third unbent fin air passage of step (g).

In another embodiment, the method includes a step between steps (b) and (c) of inserting the distal insertion end of a second elongated rod member into a second unbent fin air passage until the distal insertion end of the second elongated rod member protrudes out of an unbent fin air passage exit and the elongated rod member of step (b) structurally supports the surrounding fins.

In yet another embodiment, the method includes inserting the distal insertion end of the elongated rod member into an unbent fin entrance opening of the air passage wherein the unbent fin entrance opening is disposed opposite a bent fin air passage exit of the air passage, until the distal insertion end protrudes out of the air passage exit.

In another embodiment, step (c) of the method includes a step of inserting the distal insertion end of a first elongated rod member into a first air passage formed by unbent fins.

In accordance with embodiments of the method, there is provided another preferred method for straightening a damaged area of bent fins of a radiator having at least one bent triangular shaped air passage, wherein each air passage has a central horizontal axis. The preferred method includes a step (a) of inserting a first elongated rod member into an unbent triangular shaped air passage disposed below the at least one bent triangular shaped air passage of the radiator. Preferably, the method includes a step (b) of inserting a second elongated rod member into the at least one bent air passage, the bent air passage has a bent opening opposite a straight opening, wherein the second elongated rod member is inserted into the straight opening, pushed through the air passage, and pushed through the bent opening. The movement of the end of the second elongated rod member through the bent opening straightens the bent opening. The method preferably includes a step (c) of clamping the first elongated rod member and the second elongated rod member together while the first elongated rod member and said second elongated rod member are disposed within respective air passages, wherein the clamping of the rod members further straightens out the at least one bent air passage.

In one embodiment, the method further includes a step (d) of removing the first elongated rod member from the unbent air passage by drawing the first rod through the air passage in the same direction of the inserting in step (a). The method includes a step (e) of inserting the first elongated rod member into a second bent triangular shaped air passage disposed immediately above the at least one bent triangular shaped air passage while the second elongated rod member is disposed within the at least one bent air passage, and the second bent triangular passage has a bent opening opposite a straight opening, wherein the first elongated rod member is inserted into the straight opening, pushed through the air passage, and pushed through the bent opening. Wherein, the movement of the end of the first elongated rod member through the bent opening straightens the bent opening. The method includes a step (f) of clamping the first elongated rod member and the second elongated rod member together while the first elongated rod member and the second elongated rod member are disposed within respective air passages. The clamping of the rod members further straightens out the second triangular shaped bent air passage.

In another embodiment, the method further includes a step (g) of removing the second elongated rod member from the unbent air passage by drawing the second elongated rod member through the air passage in the same direction of the inserting in step (b). The method includes a step (h) of inserting the second elongated rod member into a third bent triangular shaped air passage disposed immediately above the second bent triangular shaped air passage while the first elongated rod member is disposed within the second bent triangular shaped air passage. The third bent triangular shaped air passage has a bent opening opposite a straight opening. The second elongated rod member is inserted into the straight opening, pushed through the air passage, and pushed through the bent opening. The movement of the end of the second elongated rod member through the bent opening straightens the bent opening. The method further includes a step (i) of clamping the second elongated rod member and the first elongated rod member together while the second elongated rod member and the first elongated rod member are disposed within respective air passages. The clamping of the rod members further straightens out the third bent triangular shaped air passage.

In yet another embodiment, the method further includes repeating steps (a) through (i) until the bent fins of the damaged area of the radiator are straightened.

In accordance with embodiments of the invention, a method for straightening one or more bent radiating fins of a damaged area of a radiator core having alternating rows of radiating fins horizontally disposed between tubes is provided. In such preferred embodiment, each two adjacent radiating fins of the same row define a V-shaped air passage for letting heat be quickly carried away by air. The preferred method includes a step (a) of inserting a first rod member into an unbent air passage disposed three rows beneath a first bent air passage. Preferably, the method includes a step (b) of inserting a second rod member into an unbent air passage disposed immediately above the first rod member. In such preferred embodiment, the method further includes a step (c) of inserting a third rod member into an unbent air passage disposed immediately above the second rod member. Preferably, the method also further includes a step (d) of inserting a fourth rod member into the first bent air passage disposed immediately above the third rod member. Accordingly, the first, second, and third rod members form a scaffolding to provide structural support to the fourth rod member as it is inserted into the first bent air passage. Whereby, the first bent air passage has a bent opening opposite a straight opening. In such step (d), the fourth rod member is inserted into the straight opening, pushed through the air passage, and through the bent opening. Therefore, the movement of the end of the fourth rod member through the bent opening straightens the bent opening.

In one embodiment, the method includes a step (e) of drawing the first rod member through the air passage in the same direction of the inserting in step (a) to remove it from the air passage. In such embodiment, the method further includes a step (f) of inserting the first rod member into a bent air passage disposed immediately above the fourth rod member. The bent air passage has a bent opening opposite a straight opening. Therefore, the first rod member is inserted into the straight opening, pushed through the air passage, and through the bent opening. The movement of the end of the first rod member through the bent opening straightens the bent opening and inserting the first rod member into the bent air passage disposed immediately above the fourth rod member reforms the scaffolding.

In another embodiment, the method includes repeating steps (a) through (f) until the bent fins of the damaged area of the radiator are straightened.

In yet another embodiment, the method further includes clamping the first rod member and the second rod member together while the rod members are disposed within their respective air passages. The clamping of the rod members further straightens out the first bent air passage.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is a top view of an exemplary fin straightening tool in accordance with embodiments of the invention;

FIG. 2A is a right side elevation view, in cross-section, thereof;

FIG. 2B is a right side elevation view, in cross-section, thereof;

FIG. 2C is a right side elevation view, in cross-section, thereof;

FIG. 3A is a back view of an exemplary fin straightening tool in accordance with embodiments of the invention;

FIG. 3B is a left side elevation view, in cross-section, thereof;

FIG. 4A is a back view of an exemplary fin straightening tool in accordance with embodiments of the invention;

FIG. 4B is a left side elevation view, in cross-section, thereof;

FIG. 5 is a front left perspective view of an exemplary radiator with bent fins in accordance with embodiments of the invention;

FIG. 6 is a front elevation view, thereof;

FIG. 7 is a front left perspective view of multiple fin straightening tools disposed within V-shaped passages of an exemplary heat radiator, in accordance with embodiments of the invention;

FIG. 8 is a back left perspective view, thereof;

FIG. 9 is a front left perspective view of two fin straightening tools disposed within V-shaped passages of an exemplary heat radiator, in accordance with embodiments of the invention;

FIG. 10 is a front left perspective view of multiple fin straightening tools disposed within V-shaped passages of an exemplary heat radiator, in accordance with embodiments of the invention;

FIG. 11 is an exemplary flowchart illustrating an exemplary method of straightening bent V-shaped air passages of an exemplary heat radiator, in accordance with embodiments of the invention;

FIG. 12 is a top front left perspective view of two fin straightening tools disposed within V-shaped passages of an exemplary heat radiator while clamped with pliers, in accordance with embodiments of the invention;

FIG. 13 is a top view of a plurality of fin straightening tools, in accordance with embodiments of the invention;

FIG. 14A is a top front left perspective view of a fin straightening tool being inserted within a V-shaped passage of an exemplary heat radiator, in accordance with embodiments of the invention;

FIG. 14B is a top front left perspective view of a fin straightening tool disposed within a V-shaped passage while a fin straightening tool is being inserted within another V-shaped passage of an exemplary heat radiator, in accordance with embodiments of the invention;

FIG. 14C is a top front left perspective view of two fin straightening tools disposed within V-shaped passages while a fin straightening tool is being inserted within another V-shaped passage of an exemplary heat radiator, in accordance with embodiments of the invention;

FIG. 14D is a top front left perspective view of three fin straightening tools disposed within V-shaped passages while a fin straightening tool is being inserted within another V-shaped passage of an exemplary heat radiator, in accordance with embodiments of the invention;

FIG. 14E is a top front left perspective view of three fin straightening tools disposed within V-shaped passages while a first fin straightening tool is being inserted within another V-shaped passage of an exemplary heat radiator, in accordance with embodiments of the invention;

FIG. 14F is a top front left perspective view of a fin straightening tool disposed within a V-shaped passage while a fin straightening tool is being removed from another V-shaped passage of an exemplary heat radiator, in accordance with embodiments of the invention;

FIG. 15 is an exemplary flowchart illustrating an exemplary method of straightening bent V-shaped air passages of an exemplary heat radiator, in accordance with embodiments of the invention; and

FIG. 16 is an exemplary flowchart illustrating an exemplary method of straightening bent V-shaped air passages of an exemplary heat radiator, in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

As used herein, “axis” means a real or imaginary straight line through a three-dimensional body. A “vertical axis” means an axis perpendicular to the ground (or put another way, an axis extending upwardly and downwardly). A “horizontal axis” means an axis parallel to the ground or a radiator frame.

As used herein, homogeneous is defined as the same in all locations, and a homogeneous material is a material of uniform composition throughout that cannot be mechanically separated into different materials. Examples of “homogeneous materials” are certain types of plastics, ceramics, glass, metals, alloys, paper, board, resins, high-density polyethylene and rubber.

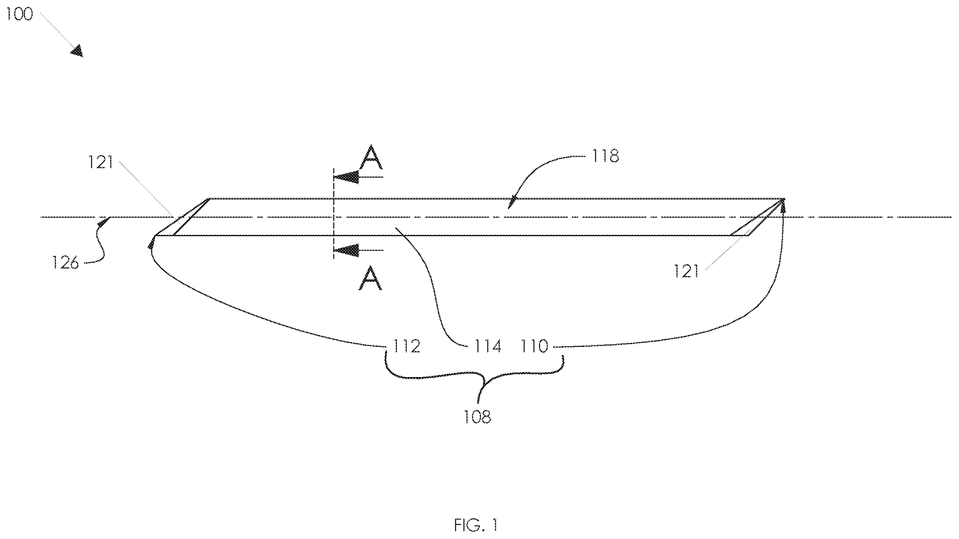

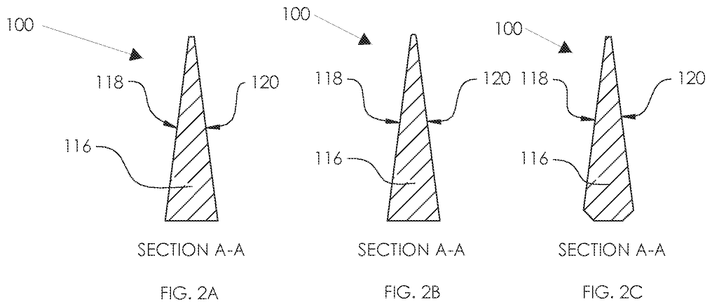

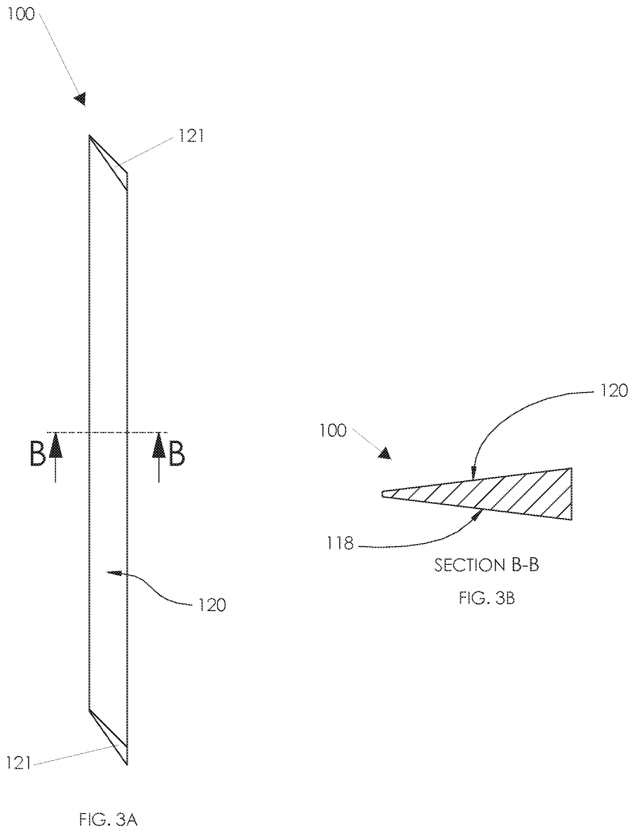

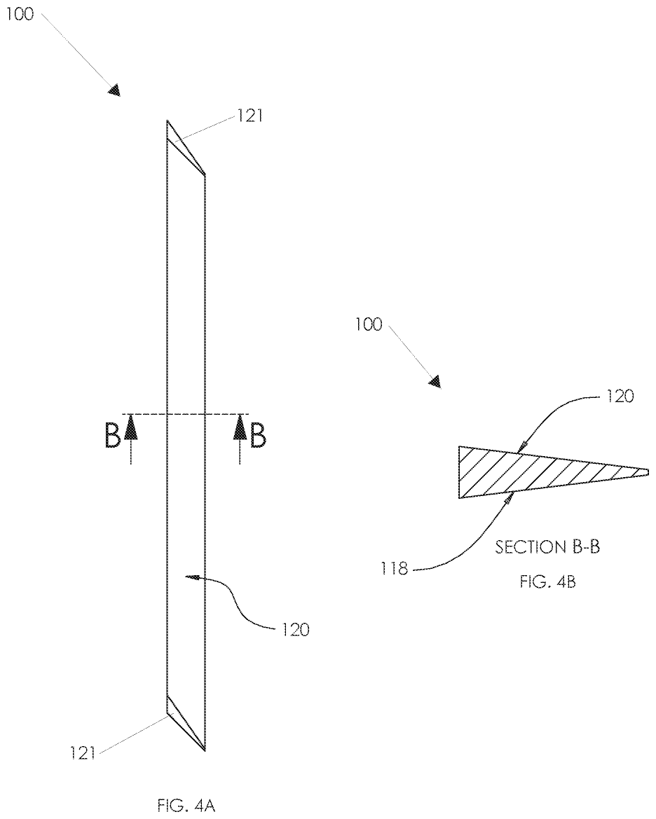

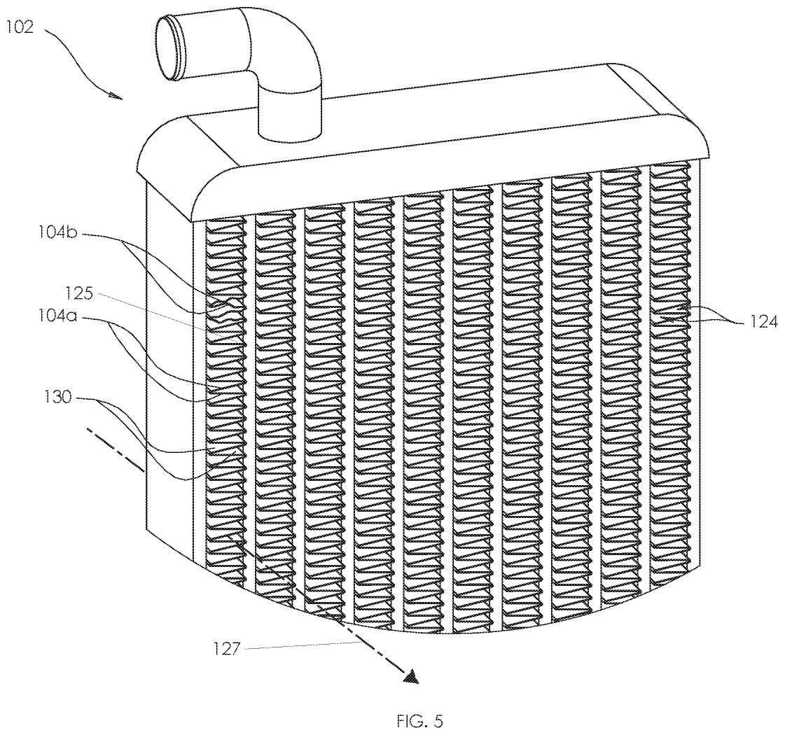

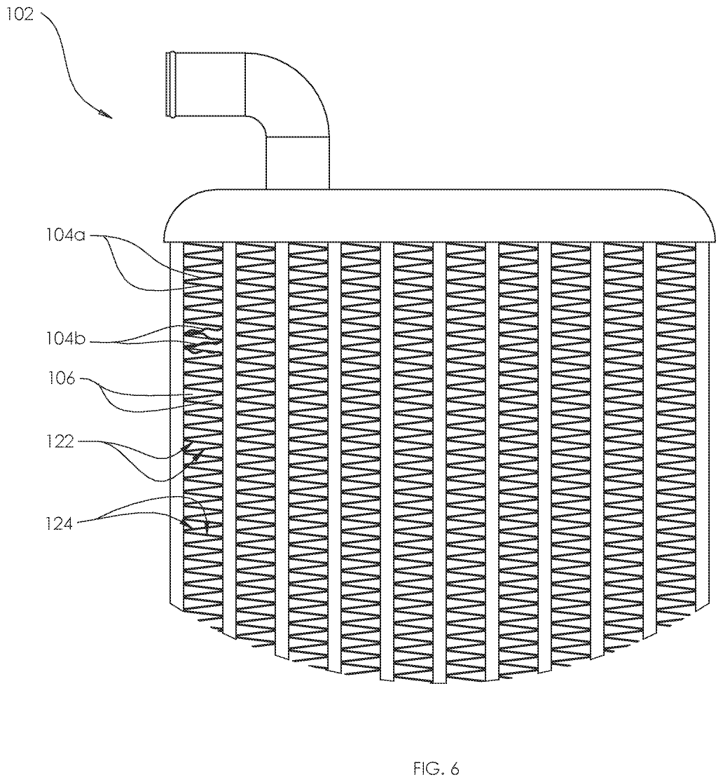

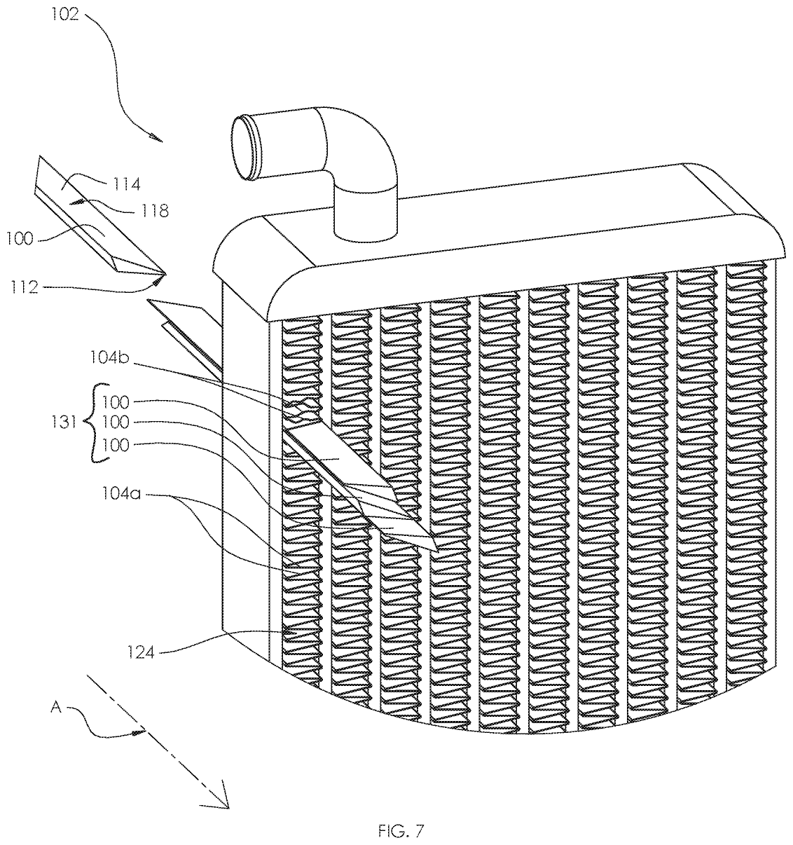

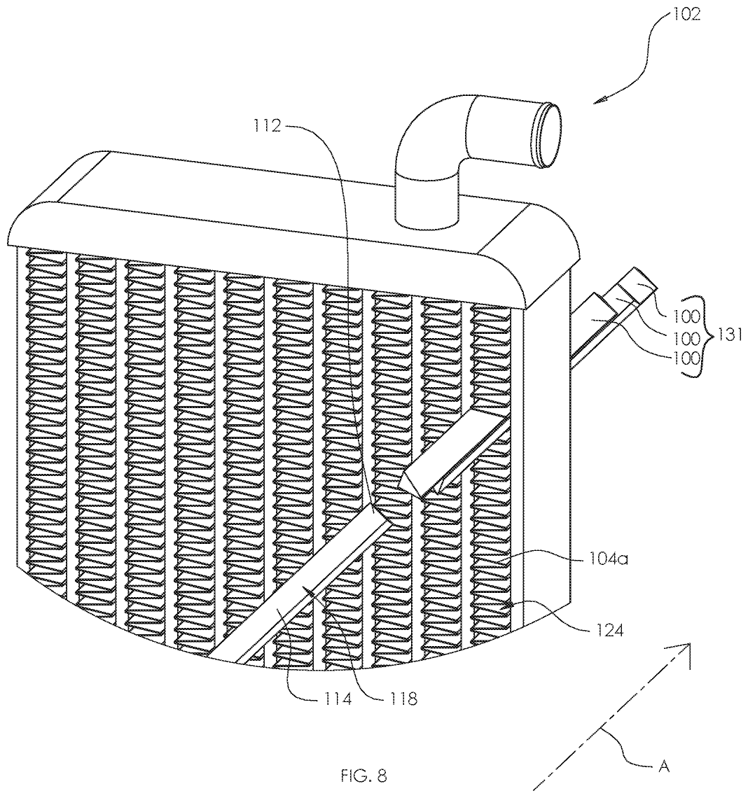

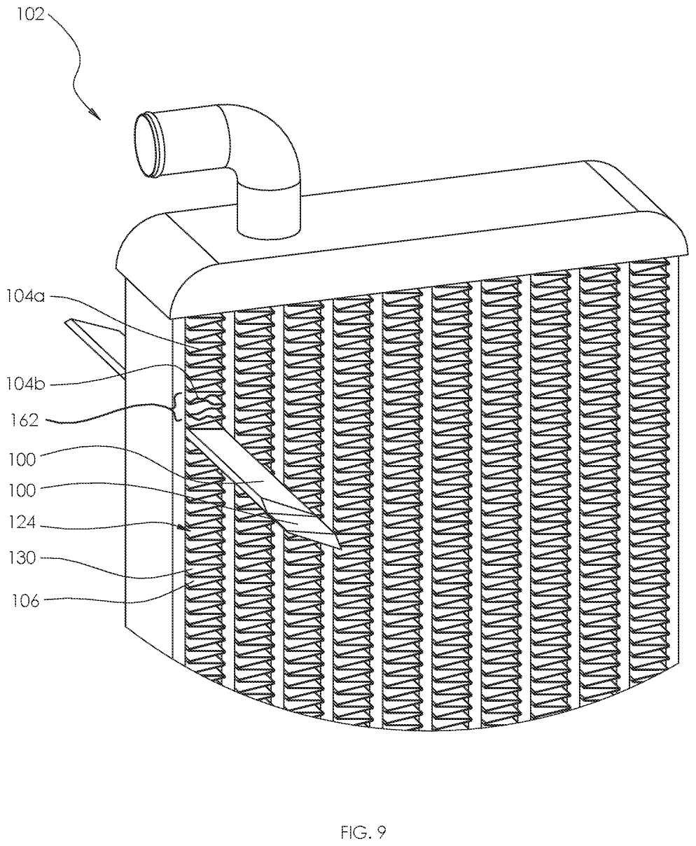

Referring initially to FIGS. 1-10 and 12-14E, the basic constructional details and principles of operation of embodiments of a fin straightening tool 100 for a heat radiator 102 configured with fins 104 forming elongated V-shaped air passages 106 therethrough. FIGS. 5-6 illustrate an exemplary heat radiator 102 configured with fins 104 forming elongated V-shaped air passages 106 therethrough. The fin straightening tool 100 is preferably an elongated rod member 108 having a proximal end 110 opposite a distal insertion end 112 and having a body 114, as shown in FIGS. 1-4B. Preferably, as illustrated in FIGS. 2A-2C, the body 114 has a triangular cross-section 116 and the body 114 forms two opposing planar surfaces 118 and 120. Opposing planar surfaces 118 and 120 are preferably configured as flat to slidingly engage opposing external flat surfaces 122 and 124 of radiator fins 104 to structurally mate against the external flat surfaces 122 and 124, as illustrated in FIGS. 7-10 and 14A-14E. Preferably, the distal insertion end 112 and the proximal end 110 of the elongated rod member 108 are angled and beveled 121, as shown in FIGS. 1, 3A, and 4A.

In one embodiment, the proximal end 110 of the fin straightening tool 100 is adapted to be grasped by a user's hand to maneuver the elongated rod member 108 through the air passage 106 to straighten bent radiator fins 104b.

Exemplary triangular cross-sections 116 of the fin straightening tool 100, as illustrated in FIGS. 2A-2C are characterized as a right triangle, an equilateral triangle, a scalene triangle, an acute triangle, an obtuse triangle, an isosceles triangle, or a trapezoid.

Preferably, the elongated rod member 108 is a thin, straight bar constructed of exemplary materials such as wood or metal, as shown in FIGS. 1, 3A, and 4A.

In a preferred embodiment, as illustrated in FIGS. 1-4B, a fin straightening device 100 is preferably an elongated rod member 108 having a body 114 extending along a longitudinal axis 126 and having a proximal end 110 opposite a distal insertion end 112. Preferably, the body 114 forms two opposing planar surfaces 118 and 120 and has a cross-section 116 adapted to geometrically align closely with a geometric cross-sectional shape of an air flow passage 106 formed between fins 104 of a radiator 102, as illustrated in FIGS. 2A-2C, 3B, and 4B.

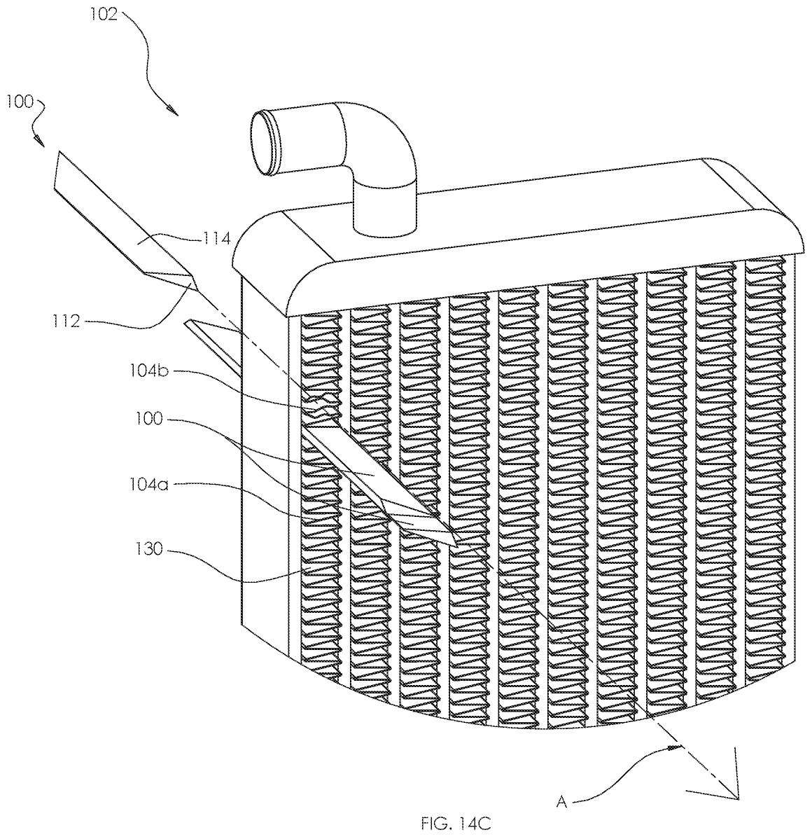

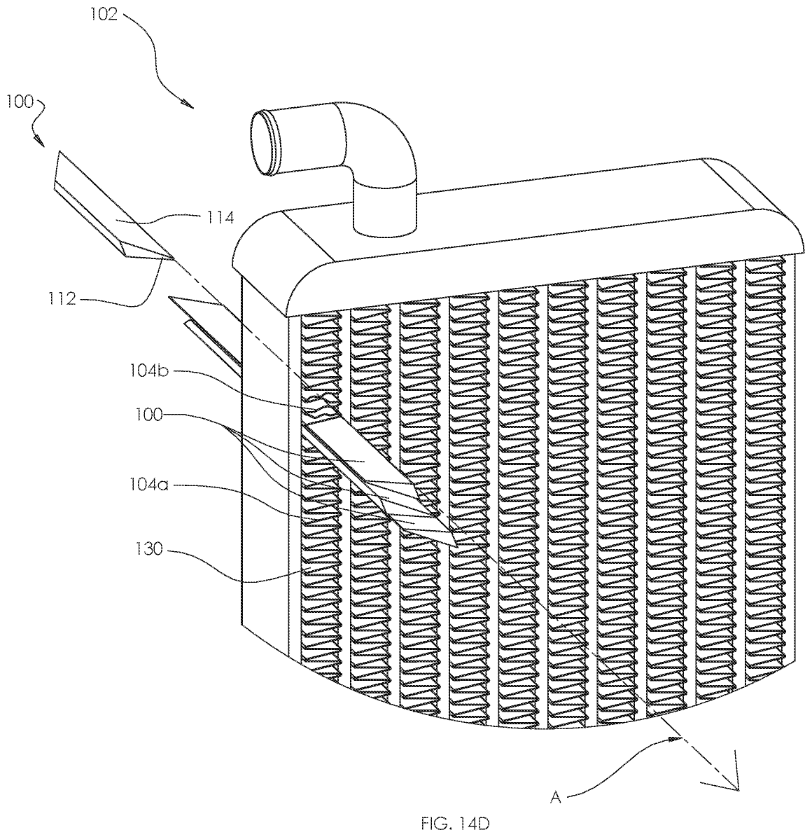

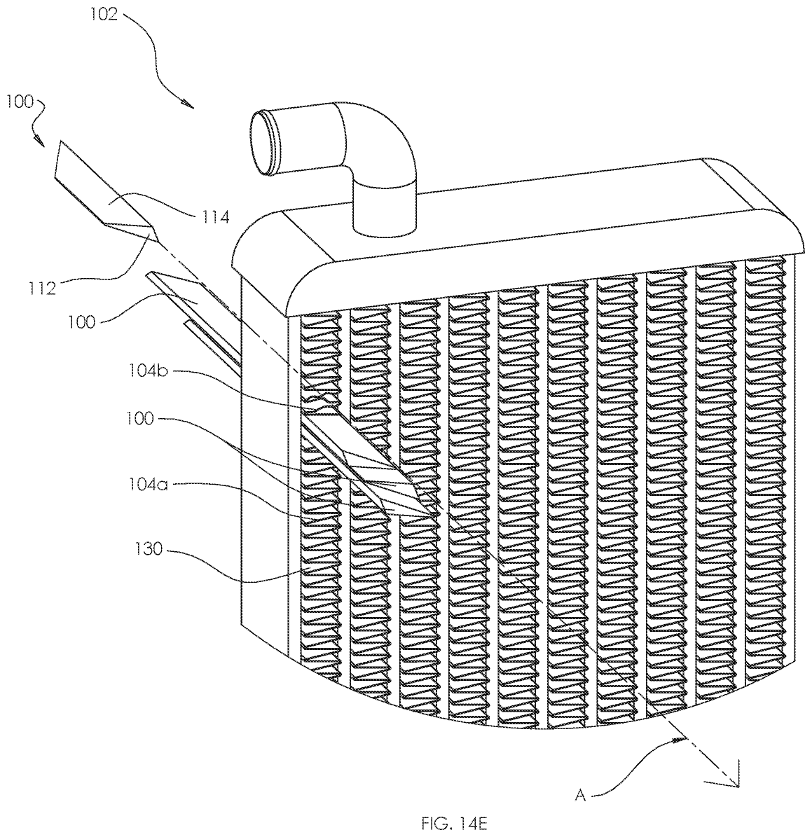

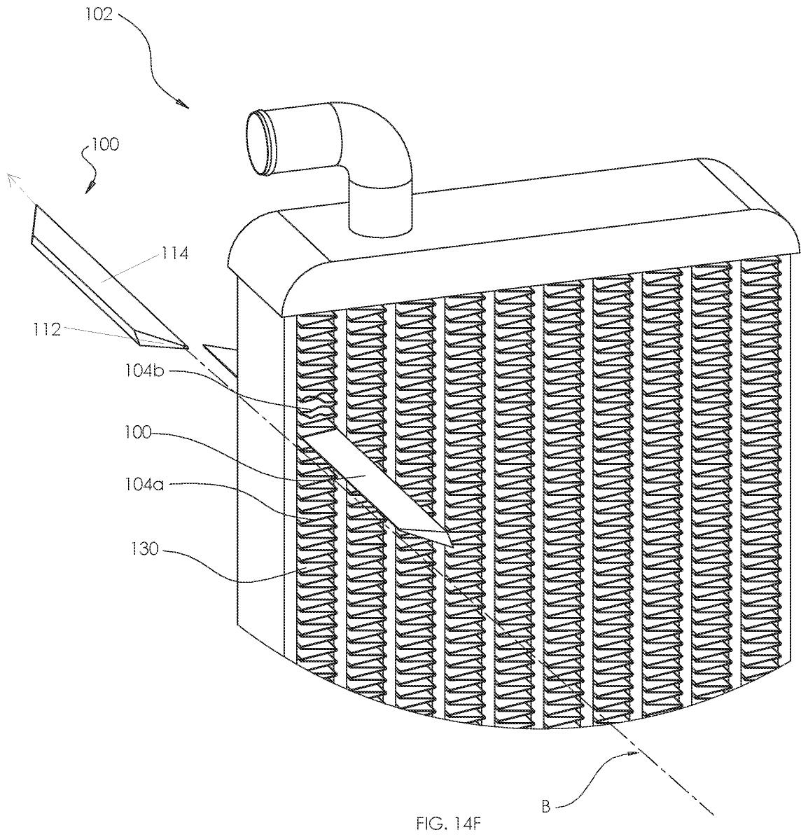

In one embodiment, as shown in FIGS. 7-10 and 14A-14E, the elongated rod member 108 is preferably secured to the radiator 102 by inserting the distal insertion end 112 of the elongated rod member 108 into an air passage opening 128 formed by radiator fins 104 and advancing the rod member 108 through the air passage 106 toward an air passage exit opening 130 in the direction of arrow A (as illustrated in FIG. 14A), such that the opposing planar surfaces 118 and 120 of the elongated rod member 108 contacts the fins 104 and moves at least a portion of the fins 104 to clear the air passage 106 until the distal insertion end 112 protrudes out of the air passage exit opening 130, as shown in FIG. 7.

In one embodiment, the geometric cross-section 116 of the elongated rod member 108 is characterized as a triangle, as shown in FIGS. 2A-2B.

In another embodiment, the geometric cross-section 116 of the elongated rod member 108 is characterized as a trapezoid, as shown in FIG. 2C.

In one embodiment, the distal insertion end 112 of the elongated rod member 108 is angled and beveled 121, as illustrated in FIG. 1.

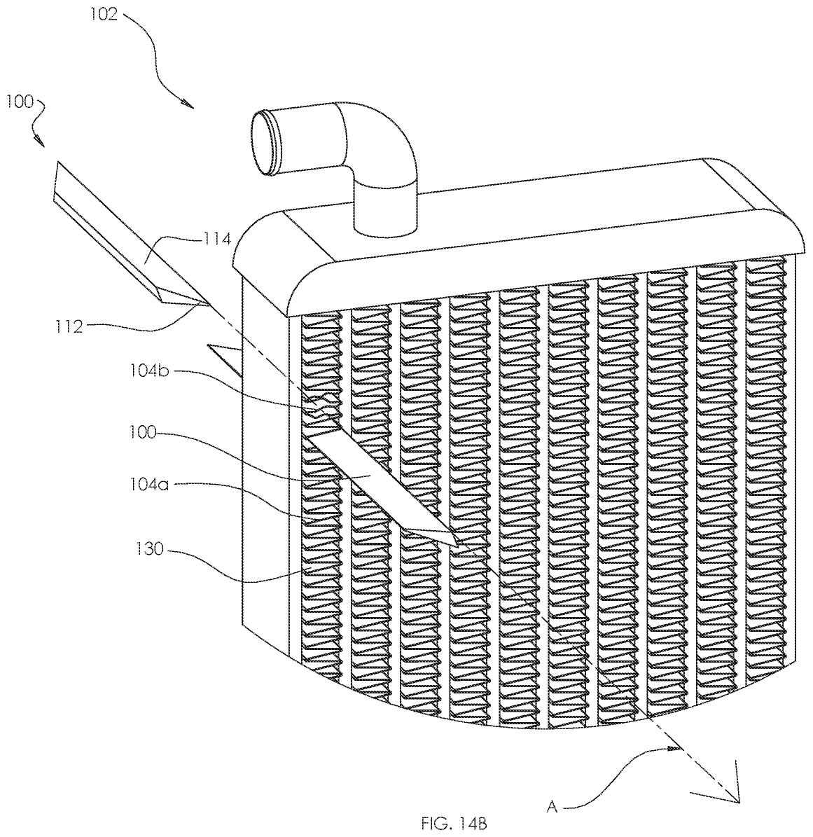

Referring to FIG. 11, in accordance with embodiments of the invention, there is provided a preferred method 132 of straightening fins 104 forming an air passage 106 of a heat radiator 102, having a first step (a) 134 of providing a plurality of elongated rod members 108, as illustrated in FIG. 13. Each elongated rod member 108 preferably has a body forming two opposing non-parallel planar surfaces 118 and 120 and a triangular cross-section 116, as illustrated in FIGS. 1-2C. The elongated rod members 108 preferably have a proximal end 110 opposite a distal insertion end 112. Each elongated rod member 108 is adapted for insertion through a fin air passage 106 defined by a plurality of fins 104, as shown in FIGS. 14A-14E. The method 132 preferably includes a second step (b) 136 of inserting the distal insertion end 112 of the elongated rod member 108 of step (b) 136 into at least one unbent fin air passage 106 until the distal insertion end 112 protrudes out of the unbent fin air passage 106 and the elongated rod member 108 of step (b) 136 structurally supports the surrounding fins 104, as illustrated in FIG. 14A. In such preferred embodiment of the method 132, a third step (c) 138 includes inserting the distal insertion end 112 of an elongated rod member 108 of step (c) 138 into a bent fin air passage 106 disposed adjacent to the at least one unbent fin air passage 106 of step (b) 136, as illustrated in FIG. 14B. In step (c) 138, the distal insertion end 112 of the elongated rod member 108 of step (c) 138 contacts the bent fins 104b and moves at least a portion of the bent fins 104 to clear the air passage 106 until the distal insertion end 112 of the elongated rod member 108 of step (c) 138 protrudes out of the bent fin air passage 106 of step (c) 138. The method 132 preferably has a fourth step (d) 140 of inserting the distal insertion 112 end of an elongated rod member 108 of step (d) 140 into a bent fin air passage 106, which is disposed adjacent to the bent fin air passage 106 of step (c) 138, as illustrated in FIG. 14C. In step (d) 140, the distal insertion end 112 of the elongated rod member 108 of step (d) 140 contacts the bent fins 104b and moves at least a portion of the bent fins 104b to clear the air passage 106 until the distal insertion end 112 protrudes out of the bent fin air passage 106 of step (d) 140. The method 132 preferably has a fifth step (e) 142 of inserting the distal insertion end 112 of an elongated rod member 108 of step (e) 142 into a bent fin air passage 106, wherein the bent fin air passage 106 is disposed adjacent to the bent fin air passage 106 of step (d) 140, as illustrated in FIG. 14D. The distal insertion end 112 of the elongated rod member 108 of step (e) 142 contacts the bent fins 104b and moves at least a portion of the bent fins 104b to clear the air passage 106 until the distal insertion end 112 of the elongated rod member 108 of step (e) 142 protrudes out of the bent fin air passage 106.

In another embodiment, as illustrated in FIG. 14E, the method 132 preferably includes a step 150 of fully advancing the elongated rod member 108 of step (b) 136 through the air passage 106 of step (b) 136 to remove the elongated rod member 108 from the radiator 102, and inserting the distal insertion end 112 of the elongated rod member 108 of step (b) 136 into a fifth air passage 106 defined by bent fins 104b. The fifth air passage 106 is disposed adjacent to the air passage of step (e) 142. The elongated rod member 108 of step (b) 136 contacts the bent fins 104b and moves at least a portion of the bent fins 104b to clear the fifth air passage 106 until the insertion end 112 protrudes out of the fifth air passage 106 exit opening 130.

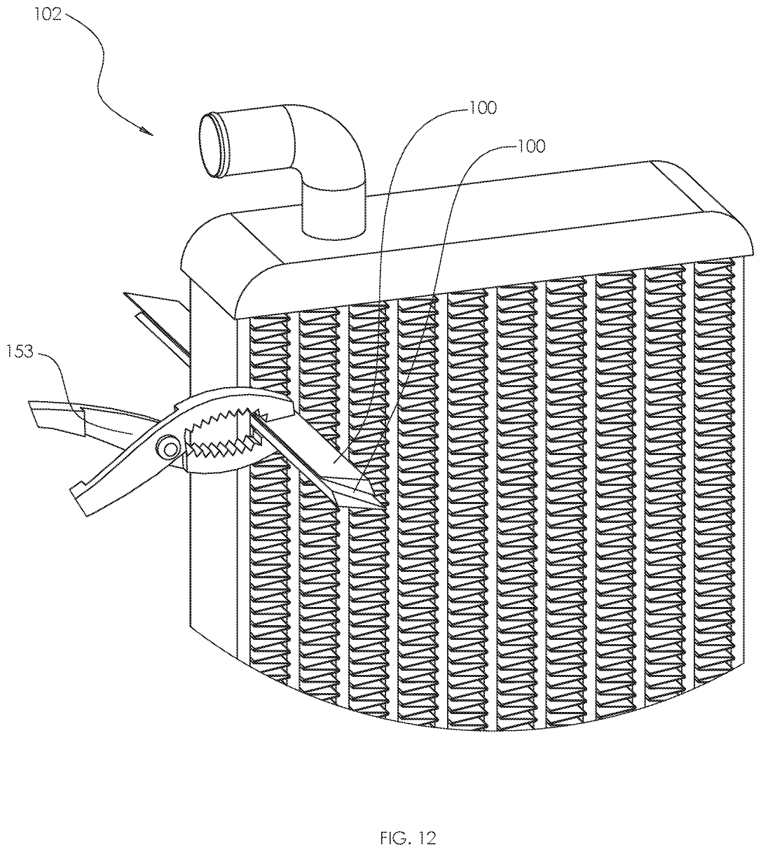

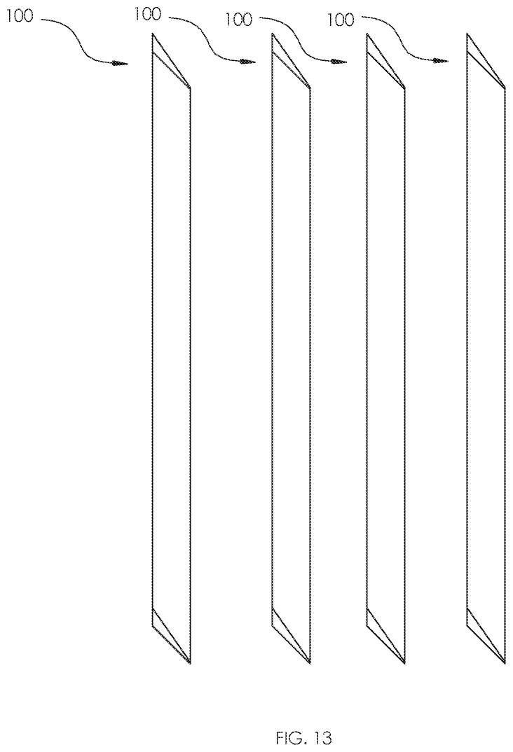

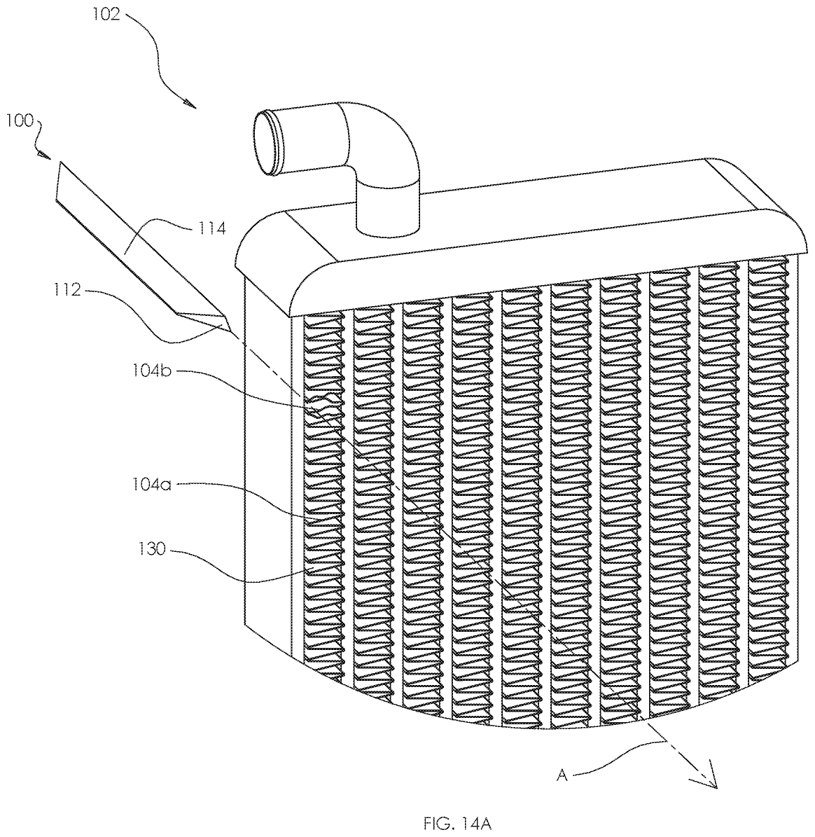

In another embodiment, as shown in FIG. 11, the method 132 further includes a step 152 of providing at least one clamping device 153, such as a pair of pliers, having a pair of crossed pivoted handles and a pair of jaws respectively fixed to the handles. In such embodiment, the method 132 having a step 154 of squeezing together at least two of the plurality of elongated rod members 108 when disposed within the air passages 106 of the radiator 102, as illustrated in FIG. 12.

In yet another embodiment, each elongated rod member 108 is characterized as having a length sufficient to extend fully through the air passage exit opening 128 of the radiator 102, as illustrated in FIGS. 7-10 and 14A-14E.

In another embodiment, the proximal end 110 of each elongated rod member 108 is adapted to be grasped by a user's hand to maneuver the elongated rod member 108 through the air passage 106 to straighten bent radiator fins 104b.

In yet another embodiment, each elongated rod member 108 is of unitary construction and is forged, molded, or machined. Preferably, the elongated rod member 108 is constructed from a material selected from a group consisting of plastic, resin, high-density polyethylene, rubber, aluminum, metal, and steel.

In one embodiment, the bent fin air passage 104b of step (c) 138 of the method 132 has an unbent fin entrance 128 opposite a bent fin exit 130 and step (c) 138 preferably includes inserting the distal insertion end 112 of the elongated rod member 108 of step (c) 138 into the unbent fin entrance 128 of the bent fin air passage 104b, as shown in FIG. 14B.

In another embodiment, as shown in FIG. 11, step (b) 136 of the method 132 further includes a step (f) 144 of inserting the distal insertion end 112 of a second elongated rod member 108 of step (b) 136 into a second unbent fin air passage 106 until the distal insertion end 112 of the second elongated rod member 108 protrudes out of the second unbent fin air passage 106 and the second unbent fin air passage 106 is disposed adjacent to the at least one unbent fin air passage 106.

In yet another embodiment, as illustrated in FIG. 11, step (f) 144 of the method 132 further includes a step (g) 146 of inserting the distal insertion end 112 of a third elongated rod member 108 of step (b) 136 into a third unbent fin air passage 106 until the distal insertion end 112 of the third elongated rod member 108 protrudes out of the third unbent fin air passage 106 and the third unbent fin air passage 106 is disposed adjacent to the second unbent fin air passage 106 of step (f) 144.

In one embodiment, as shown in FIG. 11, step (g) 146 of the method 132 further includes a step (h) 148 of inserting the distal insertion end 112 of a fourth elongated rod member 108 of step (b) 136 into a fourth unbent fin air passage 106 until the distal insertion end 112 of the fourth elongated rod member 108 protrudes out of the fourth unbent fin air passage 106 and the fourth unbent fin air passage 106 is disposed adjacent to the third unbent fin air passage 106 of step (g) 146.

In another embodiment, as shown in FIG. 11, the method 132 includes a step 156 between steps (b) 136 and (c) 138 of inserting the distal insertion end 112 of a second elongated rod member 108 into a second unbent fin air passage 106 until the distal insertion end 112 of the second elongated rod member 108 protrudes out of an unbent fin air passage exit 130 and the elongated rod member 108 of step (b) 136 structurally supports the surrounding fins 104.

In yet another embodiment, the method 132 includes inserting the distal insertion end 112 of the elongated rod member 108 into an unbent fin entrance opening 128 of the air passage 106 wherein the unbent fin entrance opening 128 is disposed opposite a bent fin air passage exit 130 of the air passage 106, until the distal insertion end 112 protrudes out of the air passage exit 130, as shown in FIG. 11. In yet another embodiment, the method 132 includes inserting the distal insertion end 112 of the elongated rod member 108 into a bent fin entrance of the air passage 106 wherein the bent fin entrance is disposed opposite an unbent fin (air passage) exit of the air passage 106, until the distal insertion end 112 protrudes out of the bent fin air passage.

In another embodiment, as shown in FIG. 11, step (c) 138 of the method includes a step 160 of inserting the distal insertion end 112 of a first elongated rod member 108 into a first air passage 106 formed by unbent fins 104a.

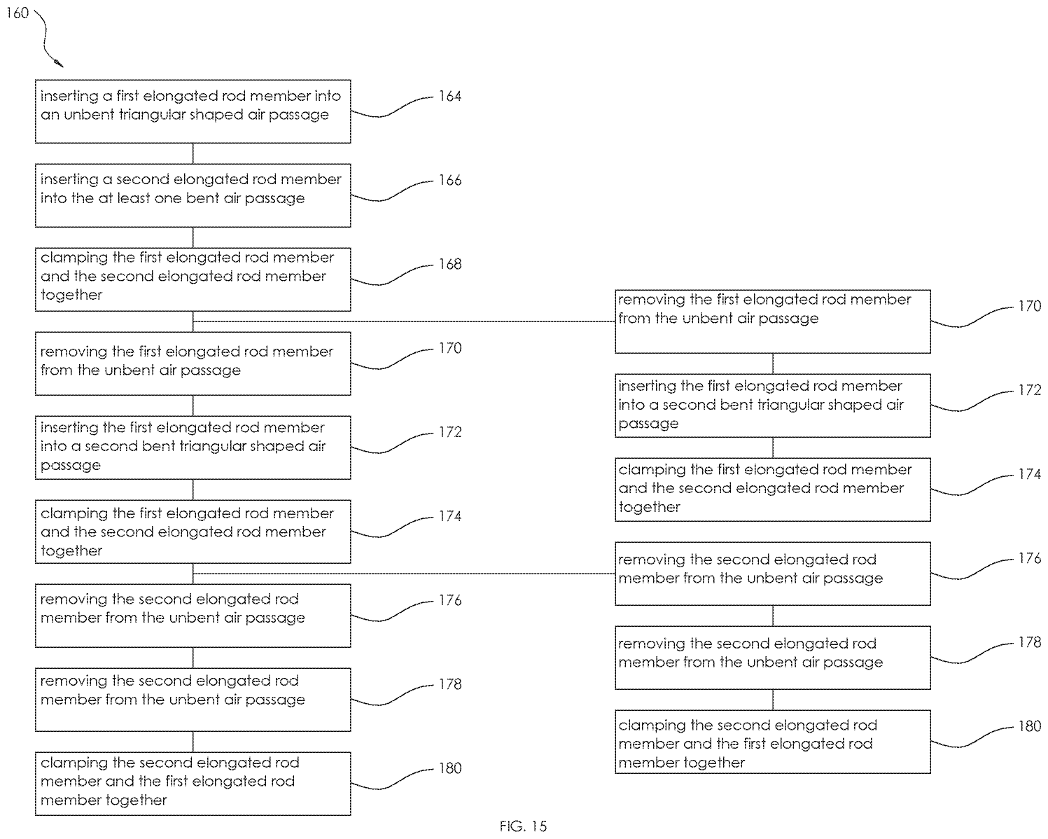

Referring to FIG. 15, in accordance with embodiments of the invention, there is provided another preferred method 160 for straightening a damaged area 162 of bent fins 104b of a radiator 102 having at least one bent triangular shaped air passage 106, having an air passage exit 130 defined by bent fins 104b and an air passage entrance 128 defined by unbent fins 104a. Each air passage 106 has a central horizontal axis 127, as illustrated in FIG. 5. The preferred method includes a step (a) 164 of inserting a first elongated rod member 108 into an unbent triangular shaped air passage 106 disposed below the at least one bent triangular shaped air passage 106 of the radiator 102, as shown in FIG. 14A. Preferably, as illustrated in FIG. 14B, the method includes a step (b) 166 of inserting a second elongated rod member 108 into the at least one bent air passage 106, the bent air passage 106 having a bent opening 130 opposite a straight opening 128, wherein the second elongated rod member 108 is inserted into the straight opening 128, pushed through the air passage 106, and pushed through the bent opening 130, and the movement of the end 112 of the second elongated rod member 108 through the bent opening 130 straightens the bent opening 130. The method 164, as illustrated in FIG. 12, preferably includes a step (c) 168 of clamping the first elongated rod member 108 and the second elongated rod member 108 together while the first elongated rod member 108 and the second elongated rod member 108 are disposed within respective air passages 106, wherein the clamping of the rod members 108 further straightens out the at least one bent air passage 106.

In one embodiment, as shown in FIG. 15, the method 160 further includes a step (d) 170 of removing the first elongated rod member 108 from the unbent air passage 106 by drawing the first elongated rod member 108 through the air passage 106 in the same direction of the inserting in step (a) 164, along Arrow B, as illustrated in FIG. 14F. Preferably, the method includes a step (e) 172 of inserting the first elongated rod member 108 into a second bent triangular shaped air passage 106 disposed immediately above the at least one bent triangular shaped air passage 106 while the second elongated rod member 108 is disposed within the at least one bent air passage 106, and the second bent triangular passage 106 having a bent opening 130 opposite a straight opening 128, wherein the first elongated rod member 108 is inserted into the straight opening 128, pushed through the air passage 106, and pushed through the bent opening 130, wherein the movement of the end 112 of the first elongated rod member 108 through the bent opening 130 straightens the bent opening 130, as illustrated in FIG. 14B. The method 160 includes a step (f) 174 of clamping the first elongated rod member 108 and the second elongated rod member 108 together while the first elongated rod member 108 and said second elongated rod member 108 are disposed within respective air passages 106, wherein the clamping of the elongated rod members 108 further straightens out the second triangular shaped bent air passage 106, as illustrated in FIG. 12.

In another embodiment, the method 160 further includes a step (g) 176 of removing the second elongated rod member 108 from the unbent air passage 106 by drawing the second elongated rod member 108 through the air passage 106 in the same direction of the inserting in step (b) 166 along the direction of Arrow B, similarly illustrated in FIG. 14F. The method preferably includes a step (h) 178 of inserting the second elongated rod member 108 into a third bent triangular shaped air passage 106 disposed immediately above the second bent triangular shaped air passage 106 while the first elongated rod member 108 is disposed within the second bent triangular shaped air passage 106, as similarly illustrated in FIG. 14B. The third bent triangular passage 106 has a bent opening 130 opposite a straight opening 128. The second elongated rod member 108 is inserted into the straight opening 128, pushed through the air passage 106, and pushed through the bent opening 130. The movement of the end of the second elongated rod member 108 through the bent opening 130 straightens the bent opening 130. The method further includes a step (i) 180 of clamping the second elongated rod member 108 and the first elongated rod member 108 together while the second elongated rod member 108 and the first elongated rod member 108 are disposed within respective air passages 106, as illustrated in FIG. 12. The clamping of the elongated rod members 108 further straightens out the third bent triangular shaped air passage 106.

In yet another embodiment, as illustrated in FIG. 15, the method 160 further includes repeating steps (a) through (i) until the bent fins 104b of the damaged area 162 of the radiator 102 are straightened.

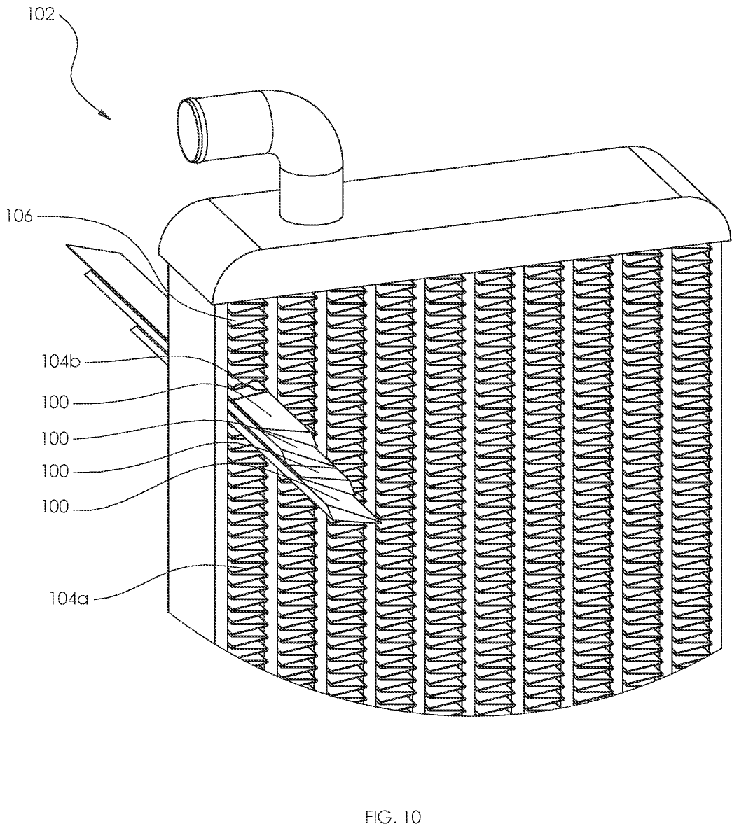

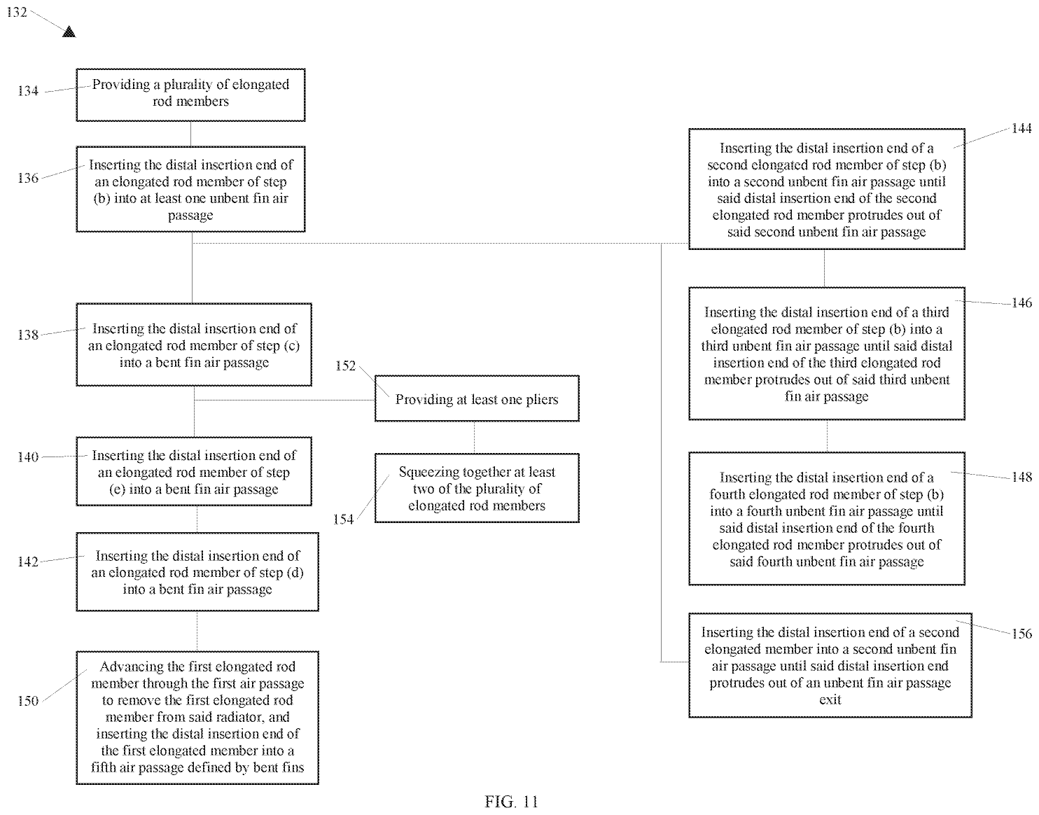

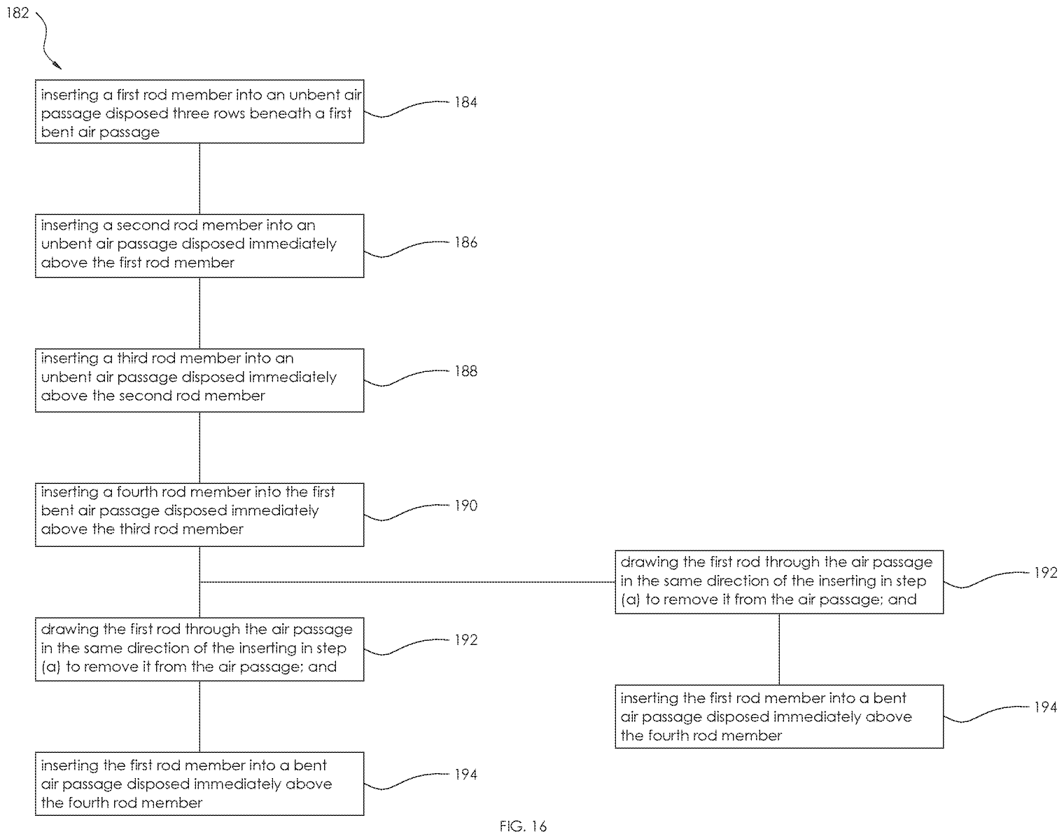

Referring to FIG. 16, in accordance with embodiments of the invention, a method 182 for straightening one or more bent radiating fins 104b of a damaged area 162 of a radiator core 102 having alternating rows of radiating fins 104 horizontally disposed between tubes is provided. In such preferred embodiment, each two adjacent radiating fins 104 of the same row define a V-shaped air passage 106 for letting heat be quickly carried away by air, as illustrated in FIGS. 5-6. The preferred method includes a step (a) 184 of inserting a first rod member 108 into an unbent air passage 106 disposed three rows beneath 125 a first bent air passage 106, as illustrated in FIG. 5. Preferably, the method 182 includes a step (b) 186 of inserting a second rod member 108 into an unbent air passage 106 disposed immediately above the first rod member 108. In such preferred embodiment, the method 182 further includes a step (c) 188 of inserting a third rod member 108 into an unbent air passage 106 disposed immediately above the second rod member 108. Preferably, as illustrated in FIG. 7, the method 182 also further includes a step (d) 190 of inserting a fourth rod member 108 into the first bent air passage 106 disposed immediately above the third rod member 108. Accordingly, the first 108, second 108, and third rod members 108 form a scaffolding 131 to provide structure to the fourth rod member 108 as it is inserted into the first bent air passage 106. Whereby, the first bent air passage 106 has a bent opening 130 opposite a straight opening 128. In such step (d) 190, the fourth rod member 108 is inserted into the straight opening 128, pushed through the air passage 106, and through the bent opening 130. Therefore, the movement of the end 112 of the fourth rod member 108 through the bent opening 130 straightens the bent opening 130, as illustrated in FIG. 10.

In one embodiment, the method 182 includes a step (e) 192 of drawing the first rod member 108 through the air passage 106 in the same direction of the inserting in step (a) 184 to remove it from the air passage 106, as illustrated in FIG. 16. In such embodiment, the method 182 further includes a step (f) 194 of inserting the first rod member 108 into a bent air passage 106 disposed immediately above the fourth rod member 108, as similarly illustrated in FIG. 7. The bent air passage 106 has a bent opening 130 opposite a straight opening 128. Therefore, the first rod member 108 is inserted into the straight opening 128, pushed through the air passage 106, and through the bent opening 130. The movement of the end 112 of the first rod member 108 through the bent opening 130 straightens the bent opening 130 and inserting the first rod member 108 into the bent air passage 106 disposed immediately above the fourth rod member 108 reforms the scaffolding 131.

In another embodiment, as illustrated in FIG. 16, the method 182 includes repeating steps (a) 184 through (f) 194 until the bent fins 104b of the damaged area 162 of the radiator 102 are straightened.

In yet another embodiment, as illustrated in FIG. 12, the method 182 further includes clamping 154 the first rod member 108 and the second rod member 108 together while the rod members 108 are disposed within their respective air passages 106. The clamping 154 of the rod members 108 further straightens out the first bent air passage 106.

All U.S. patents and publications identified herein are incorporated in their entirety by reference thereto.

The claimed invention is:

1. A method of straightening fins forming an air passage of a heat radiator, comprising the steps of:
(a) providing a plurality of elongated rod members, wherein each elongated rod member comprises a body forming two opposing non-parallel planar surfaces and having a triangular cross-section, said rod member having a proximal end opposite a distal insertion end;
(b) inserting the distal insertion end of an elongated rod member of step (b) into at least one unbent fin air passage until said distal insertion end protrudes out of said unbent fin air passage, wherein the elongated rod member structurally supports the surrounding fins;
(c) inserting the distal insertion end of an elongated rod member of step (c) into a bent fin air passage, wherein the bent fin air passage is disposed adjacent to the at least one unbent fin air passage of step (b), wherein the distal insertion end of said elongated rod member of step (c) contacts said bent fins and moves at least a portion of said fins to clear said passage until said distal insertion end protrudes out of said bent fin air passage of step (c);
(d) inserting the distal insertion end of an elongated rod member of step (d) into a bent fin air passage, wherein the bent fin air passage is disposed adjacent to the bent fin air passage of step (c), wherein the distal insertion end of said elongated rod member of step (d) contacts said bent fins and moves at least a portion of said fins to clear said passage until said distal insertion end protrudes out of said bent fin air passage of step (d); and
(e) inserting the distal insertion end of an elongated rod member of step (e) into a bent fin air passage, wherein the bent fin air passage is disposed adjacent to the bent fin air passage of step (d), wherein the distal insertion end of said elongated rod member of step (e) contacts said fins and moves at least a portion of said fins to clear said passage until said distal insertion end protrudes out of said bent fin air passage of step (e).

2. The method of claim 1, further comprising the step of fully advancing the elongated rod member of step (b) through the at least one unbent fin air passage to remove the elongated rod member of step (b) from said radiator, and inserting the distal insertion end of the elongated rod member of step (b) into a bent fin air passage disposed adjacent to the bent fin air passage of step (e), wherein the elongated rod member of step (b) contacts said fins and moves at least a portion of said fins to clear said passage until said insertion end protrudes out of said bent fin air passage disposed adjacent to the bent fin air passage of step (e).

3. The method of claim 1, further comprising the steps of providing at least one pliers comprising a pair of crossed pivoted handles and a pair of jaws respectively fixed to the handles, and further comprising a step of squeezing together at least two of the plurality of elongated rod members when disposed within the air passages of said radiator.

4. The method of claim 1, wherein each elongated member is characterized as having a length sufficient to extend fully through the air passage of the radiator.

5. The method of claim 1, wherein the proximal end of each elongated rod member is adapted to be grasped by a user's hand to maneuver said elongated rod member through the air passage to straighten bent radiator fins.

6. The method of claim 1, wherein each elongated rod member is of unitary construction manufactured from a material selected from a group consisting of plastic, resin, high-density polyethylene, rubber, aluminum, metal, and steel.

7. The method of claim 1, wherein the bent fin air passage of step (c) comprises an unbent fin entrance opposite a bent fin exit, wherein said step (c) comprises inserting the distal insertion end of the elongated rod member of step (c) into the unbent fin entrance of the bent fin air passage.

8. The method of claim 1, wherein step (b) further comprises a step of:
(f) inserting the distal insertion end of a second elongated rod member of step (b) into a second unbent fin air passage until said distal insertion end of the second elongated rod member protrudes out of said second unbent fin air passage, wherein the second unbent fin air passage is disposed adjacent to the at least one unbent fin air passage.

9. The method of claim 8, wherein step (f) further comprises a step of:
(g) inserting the distal insertion end of a third elongated rod member of step (b) into a third unbent fin air passage until said distal insertion end of the third elongated rod member protrudes out of said third unbent fin air passage, wherein the third unbent fin air passage is disposed adjacent to the second unbent fin air passage.

10. The method claim 9, wherein step (g) further comprises a step of:
(h) inserting the distal insertion end of a fourth elongated rod member of step (b) into a fourth unbent fin air passage until said distal insertion end of the fourth elongated rod member protrudes out of said fourth unbent fin air passage, wherein the fourth unbent fin air passage is disposed adjacent to the third unbent fin air passage.

11. The method of claim 1, further comprising a step (i) between steps (b) and (c) of inserting the distal insertion end of a second elongated member into a second unbent fin air passage until said distal insertion end protrudes out of an unbent fin air passage exit, wherein the elongated rod member of step (b) structurally supports the surrounding fins.

12. The method of claim 1, wherein inserting the distal insertion end of the elongated rod member of step (b) into the at least one unbent fin air passage contacts and moves at least a portion of the bent fins of the bent fin air passage of step (c).

13. The method of claim 1, wherein the bent fin air passage of step (c) comprises a bent fin entrance opposite an unbent fin exit, wherein said step (c) comprises inserting the distal insertion end of the elongated rod member of step (c) into the bent fin entrance of the bent fin air passage.

14. A method for straightening a damaged area of bent fins of a radiator having at least one bent triangular shaped air passage, wherein each air passage comprises a central horizontal axis, comprising:
(a) inserting a first elongated rod member into an unbent triangular shaped air passage disposed below the at least one bent triangular shaped air passage of the radiator;
(b) inserting a second elongated rod member into the at least one bent air passage, said bent air passage having a bent opening opposite a straight opening, wherein the second elongated rod member is inserted into the straight opening, pushed through the air passage, and pushed through the bent opening, wherein the movement of the end of the second elongated rod member through the bent opening straightens the bent opening; and
(c) clamping the first elongated rod member and the second elongated rod member together while said first elongated rod member and said second elongated rod member are disposed within respective air passages, wherein the clamping of the rod members further straightens out the at least one bent passage.

15. The method of claim 14, further comprising:
(d) removing the first elongated rod member from the unbent air passage by drawing the first rod through the air passage in the same direction of the inserting in step (a);
(e) inserting the first elongated rod member into a second bent triangular shaped air passage disposed immediately above the at least one bent triangular shaped air passage while the second elongated rod member is disposed within the at least one bent air passage, said second bent triangular passage having a bent opening opposite a straight opening, wherein the first elongated rod member is inserted into the straight opening, pushed through the air passage, and pushed through the bent opening, wherein the movement of the end of the first elongated rod member through the bent opening straightens the bent opening; and
(f) clamping the first elongated rod member and the second elongated rod member together while said first elongated rod member and said second elongated rod member are disposed within respective air passages, wherein the clamping of the rod members further straightens out the second triangular shaped bent air passage.

16. The method of claim 15, further comprising:
(g) removing the second elongated rod member from the unbent air passage by drawing the second elongated rod through the air passage in the same direction of the inserting in step (b);
(h) inserting the second elongated rod member into a third bent triangular shaped air passage disposed immediately above the second bent triangular shaped air passage while the first elongated rod member is disposed within the second bent triangular shaped air passage, said third bent triangular passage having a bent opening opposite a straight opening, wherein the second elongated rod member is inserted into the straight opening, pushed through the air passage, and pushed through the bent opening, wherein the movement of the end of the second elongated rod member through the bent opening straightens the bent opening; and
(i) clamping the second elongated rod member and the first elongated rod member together while said second elongated rod member and said first elongated rod member are disposed within respective air passages, wherein the clamping of the rod members further straightens out the third bent triangular shaped air passage.

17. The method of claim 16, wherein steps (a) through (i) are repeated until the bent fins of the damaged area of the radiator are straightened.

18. A method for straightening one or more bent radiating fins of a damaged area of a radiator core having alternating rows of radiating fins horizontally disposed between tubes, wherein each two adjacent radiating fins of the same row define a V-shaped air passage, comprising:
(a) inserting a first rod member into an unbent air passage disposed three rows beneath a first bent air passage;
(b) inserting a second rod member into an unbent air passage disposed immediately above the first rod member;
(c) inserting a third rod member into an unbent air passage disposed immediately above the second rod member, wherein the first, second, and third rod members form a scaffolding to provide structural support to the fourth rod member as it is inserted into the first bent air passage; and
(d) inserting a fourth rod member into the first bent air passage disposed immediately above the third rod member, said first bent air passage having a bent opening opposite a straight opening, wherein the fourth rod member is inserted into the straight opening, pushed through the air passage, and through the bent opening, wherein the movement of the end of the fourth rod member through the bent opening straightens the bent opening.

19. The method of claim 18, further comprising:
(e) drawing the first rod through the air passage in the same direction of the inserting in step (a) to remove it from the air passage; and
(f) inserting the first rod member into a bent air passage disposed immediately above the fourth rod member, said bent air passage having a bent opening opposite a straight opening, wherein the first rod member is inserted into the straight opening, pushed through the air passage, and through the bent opening, wherein the movement of the end of the first rod member through the bent opening straightens the bent opening, and wherein inserting the first rod member into the bent air passage disposed immediately above the fourth rod member reforms the scaffolding.

20. The method of claim 19, wherein steps (a) through (f) are repeated until the bent fins of the damaged area of the radiator are straightened.

21. The method of claim 18, further comprising clamping the first rod member, the second rod member, the third rod member, and the fourth rod member together while the rod members are disposed within their respective air passages, wherein the clamping of the rod members further straightens out the first bent air passage.

22. A fin straightening tool for a heat radiator configured with fins forming elongated V-shaped air passages therethrough, the fin straightening tool comprising:
an elongated rod member comprising a body having a proximal end opposite a distal insertion end, said body forming two opposing planar surfaces;
wherein said opposing planar surfaces are configured as flat to slidingly engage opposing external flat surfaces of radiator fins to structurally mate against said external flat surfaces;
wherein the distal insertion end of said rod member is angled and beveled.

23. The fin straightening tool of claim 22, wherein the proximal end is adapted to be grasped by a user's hand to maneuver said rod member through the air passage to straighten bent radiator fins.

24. The fin straightening tool of claim 22, wherein the triangular cross-section is characterized as a right triangle.

25. The fin straightening tool of claim 22, wherein the triangular cross-section is characterized as an equilateral triangle.

26. The fin straightening tool of claim 22, wherein the triangular cross-section is characterized as a scalene triangle.

27. The fin straightening tool of claim 22, wherein the triangular cross-section is characterized as an acute triangle.

28. The fin straightening tool of claim 22, wherein the triangular cross-section is characterized as an obtuse triangle.

29. The fin straightening tool of claim 22, wherein the triangular cross-section is characterized as an isosceles triangle, wherein the thickness of the triangular cross-section of the rod member tapers down from the proximal end to a thinner cross-section at the distal end.

30. The fin straightening tool of claim 22, wherein the triangular cross-section is characterized as a trapezoid.

31. A fin straightening device comprising:
an elongated rod member having a body extending along a longitudinal axis and having a proximal end opposite a distal insertion end, the body forming two opposing planar surfaces and having a cross-section adapted to geometrically align closely with a geometric cross-sectional shape of an air flow passage formed between fins of a radiator;
wherein said elongated rod member is secured to said radiator by inserting said distal insertion end of said rod member into an air passage opening formed by radiator fins and advancing said rod member through said air passage toward an air passage exit opening such that the opposing planar surfaces of the rod member contacts said fins and moves at least a portion of said fins to clear said passage until said distal insertion end protrudes out of the air passage exit opening.

32. The fin straightening device of claim 31, wherein the geometric cross-section of said rod is characterized as a triangle.

33. The fin straightening device of claim 31, wherein the geometric cross-section of said rod is characterized as trapezoidal, wherein said trapezoidal shape is adapted to closely align and pair with a radiator in a lock and key style arrangement.

34. The fin straightening device of claim 31, wherein the distal insertion end of said rod member is angled and beveled.
